(19) United States
(12) Patent Application Publication
(10) Pub. No.: US 2006/0091675 A1
(43) Pub. Date: May 4, 2006

(54) Apparatus for generating electric power using wind energy

(76) Inventor: Chih-Fong Chen, Kaohsiung City (TW)

Correspondence Address: SCHWEGMAN, LUNDBERG, WOESSNER & KLUTH, 1600 TCF TOWER, 121 SOUTH EIGHT STREET, MINNEAPOLIS, MN, 55402, US

(21) Appl. No.: 11/225,474

(22) Filed: Sep. 13, 2005

(30) Foreign Application Priority Data
Oct. 22, 2004 (TW) 093216898

(51) Int. Cl. F03D 9/00; H02P 9/04

(52) U.S. Cl. 290/44

(57) ABSTRACT

An apparatus for generating electric power using wind energy includes a structural frame configured with a vertical array of accommodating spaces and having two pairs of sides. Each pair of the sides are opposite to each other. Each of a plurality of electric generating units includes a windmill mounted rotatably in a respective accommodating space and operable to face wind and to convert wind energy into a mechanical rotary power output, and a generator coupled to the windmill to convert the mechanical rotary power output into electric power. Each of four wind guiding units is disposed on a respective corner of the structural frame, and has a wind guiding member. The wind guiding members of any two adjacent wind guiding units define a wind channel that converges toward a corresponding side of the structural frame.

### BACKGROUND OF THE INVENTION

1. Field of the Invention

The invention relates to an apparatus for generating electric power using wind energy.

2. Description of the Related Art

Since wind energy is widely available, inexhaustible, clean, and an inexpensive energy source as compared to water energy, thermal energy generated using fossil fuel, and nuclear energy, electric power generation using wind energy is very popular.

Referring to FIG. 1, a conventional power generating station is shown to include a plurality of wind power generators 1 disposed spacedly apart from each other. However, the arrangement of the wind power generators 1 cannot ensure stable electric generation for an area having an unstable amount of wind. In order to minimize interference between adjacent ones of the wind power generators 1, a distance between adjacent wind power generators 1 should be about 3˜6 times of the diameter of a wind vane 12 of the wind power generator 1, thereby resulting in a relatively large operating space requirement.

Referring to FIGS. 2 and 3, an apparatus 2 for generating electric power from wind has been disclosed in European Patent Application Publication No. 1544461. In the aforesaid apparatus 2, a structural frame 22 is mounted rotatably on a base 21. An orientation control unit 25 is coupled to the base 21 and the structural frame 22 for varying orientation of the structural frame 22 relative to the base 21 based on a wind direction signal generated by a wind direction sensor 251 in accordance with the wind direction. However, since the structural frame 22 has a huge size and can reach up to 60 meters in height, it needs an extremely large amount of power to rotate the structural frame 22 during use.

### SUMMARY OF THE INVENTION

Therefore, the object of the present invention is to provide an apparatus for generating electric power from wind energy that can overcome the aforesaid drawbacks of the prior art.

According to the present invention, there is provided an apparatus for generating electric power from wind that blows in a wind direction. The apparatus comprises:

a structural frame configured with a vertical array of accommodating spaces and having two pairs of sides, each pair of the sides being opposite to each other, the sides defining four corners;

a plurality of electric generating units, each of which includes
a windmill mounted rotatably in a respective one of the accommodating spaces and operable so as to face the wind and so as to convert wind energy into a mechanical rotary power output, and
a generator coupled to the windmill to convert the mechanical rotary power output into electric power; and

four wind guiding units, each of which is disposed on a respective one of the corners of the structural frame and has a wind guiding member, the wind guiding members of any adjacent two of the wind guiding units defining a wind channel that converges toward a corresponding one of the sides of the structural frame therebetween, each of the wind channels having a wind outlet end proximate to the corresponding one of the sides of the structural frame, and a wind inlet end distal from and wider than the corresponding one of the sides of the structural frame.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view showing a conventional power generating station for generating electric power from wind;

FIG. 2 is a schematic view showing a conventional apparatus for generating electric power from wind;

FIG. 3 is a schematic top view illustrating a pair of the conventional apparatus of FIG. 2 in a state of use;

FIG. 4 is a perspective view showing the first preferred embodiment of an apparatus for generating electric power from wind according to the present invention;

FIG. 5 is a schematic circuit block diagram illustrating an electric generating unit of the first preferred embodiment;

FIG. 6 is a schematic top view illustrating the first preferred embodiment in a state of use;

FIG. 7 is a perspective view showing the second preferred embodiment of an apparatus for generating electric power from wind according to the present invention;

FIG. 8 is a schematic circuit block diagram illustrating a positioning member, a corresponding electric generating unit and a corresponding motor controller of the second preferred embodiment;

FIG. 9 is a fragmentary schematic view illustrating a wind guiding unit of the second preferred embodiment in a state of use; and

FIG. 10 is a fragmentary schematic view illustrating the wind guiding unit of the second preferred embodiment in another state of use.

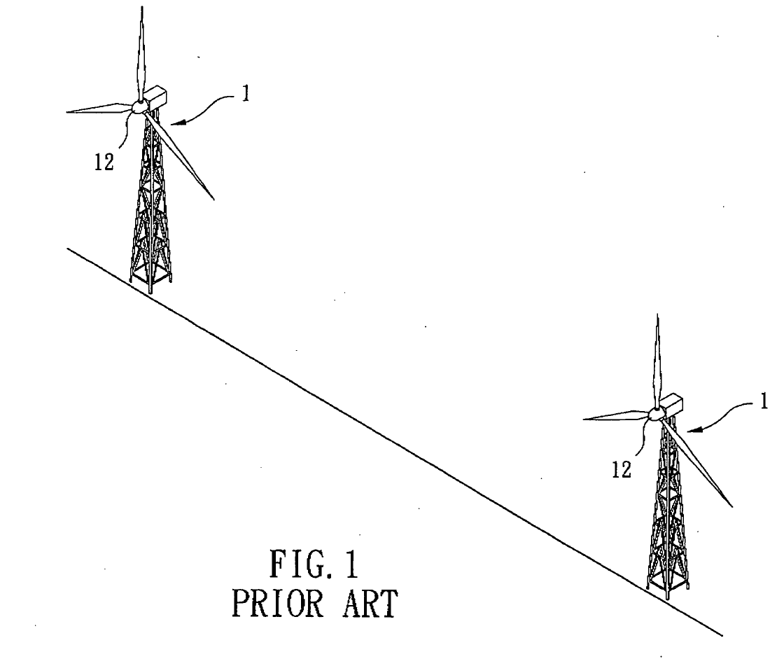

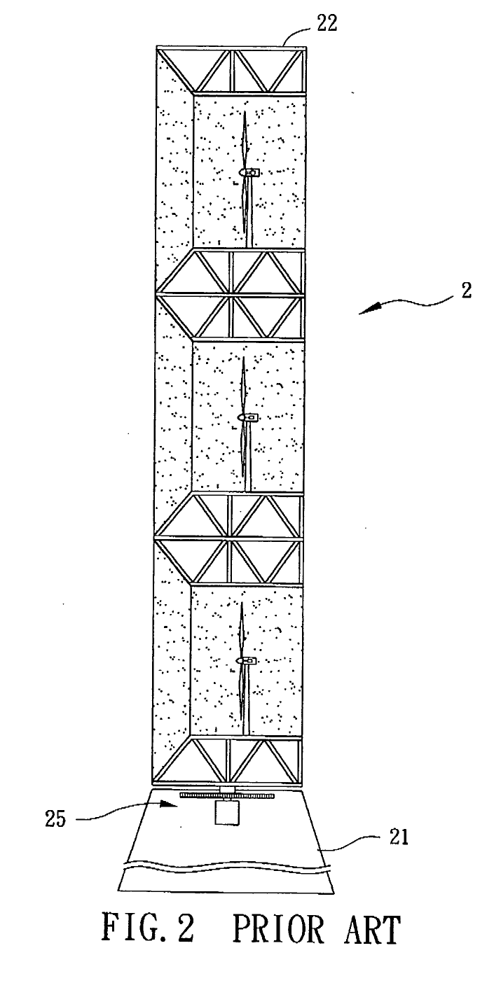

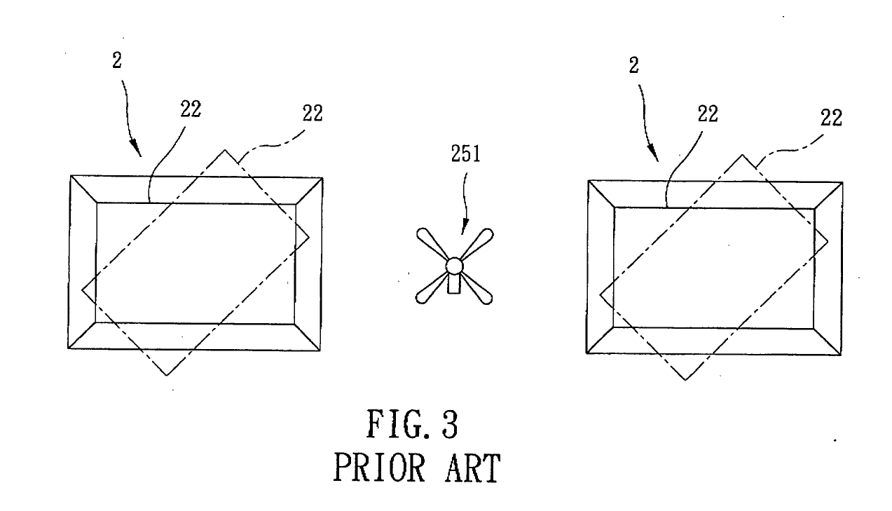

### DETAILED DESCRIPTION OF THE PREFERRED EMBODIMENTS

Before the present invention is described in greater detail, it should be noted that like elements are denoted by the same reference numerals throughout the disclosure.

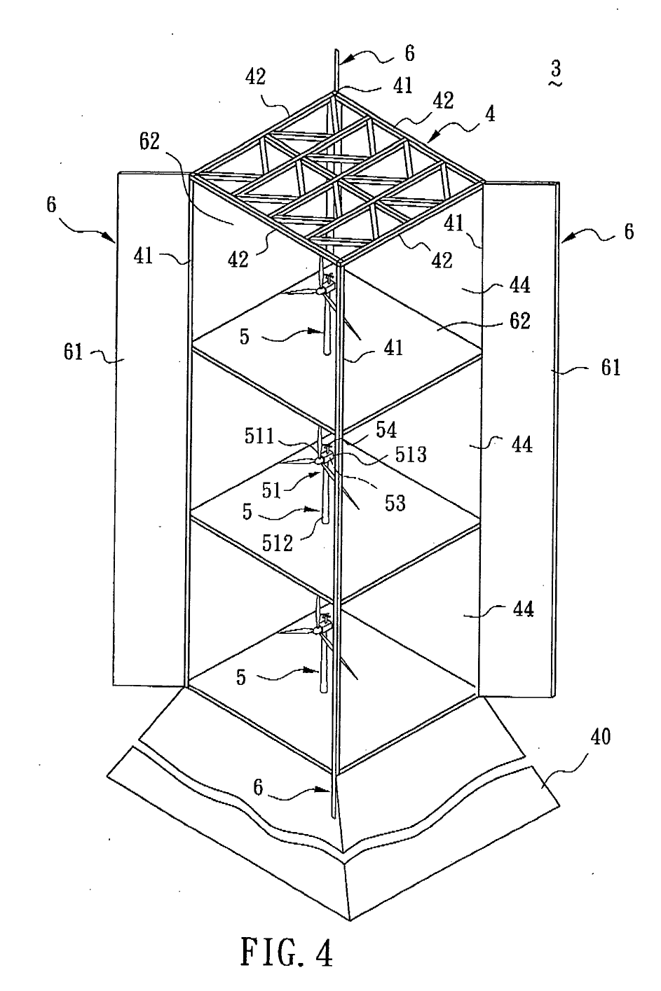

Referring to FIG. 4, the first preferred embodiment of an apparatus 3 for generating electric power from wind according to the present invention is shown to include a base 40, a structural frame 4, a plurality of electric generating units 5, and four wind guiding units 6. The wind blows in a wind direction.

In this embodiment, the structural frame 4 is fixed on the base 40, is configured with a single vertical column, i.e., a 3×1 array, of accommodating spaces 44, and has two pairs of sides 42. Each pair of the sides 42 are opposite to each other. The sides 42 define four corners 41. In this embodiment, each accommodating space 44 is rectangular.

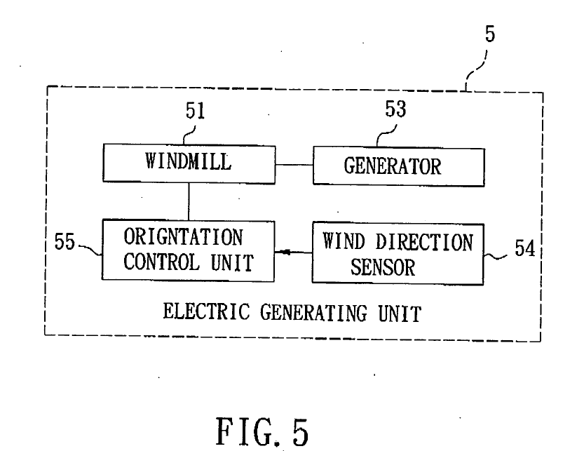

Referring further to FIG. 5, in this embodiment, each electric generating unit 5 includes a windmill 51, a generator 53, a wind direction sensor 54, and an orientation control unit 55.

For each electric generating unit 5, the windmill 51 is mounted rotatably in a respective one of the accommodating spaces 44, and is operable so as to face the wind and so as to convert wind energy into a mechanical rotary power output. In this embodiment, the windmill 51 includes an upright mast 512 disposed in the respective one of the accommodating spaces 44 and mounted on the structural frame 4, a casing 513 mounted rotatably on a top end of the upright mast 512, and a wind vane 511 mounted rotatably on the casing 513, as shown in FIG. 4.

The generator 53 is disposed in the casing 513, and is coupled to the windmill 51 to convert the mechanical rotary power output into electric power.

In this embodiment, the wind direction sensor 54 is mounted on the casing 513, and generates a wind direction signal in accordance with the wind direction.

The orientation control unit 55 is coupled electrically to the wind direction sensor 54 and the windmill 51, and rotates the casing 513 about a vertical axis in response to the wind direction signal received from the wind direction sensor 54 so as to enable the windmill 51 to face the wind.

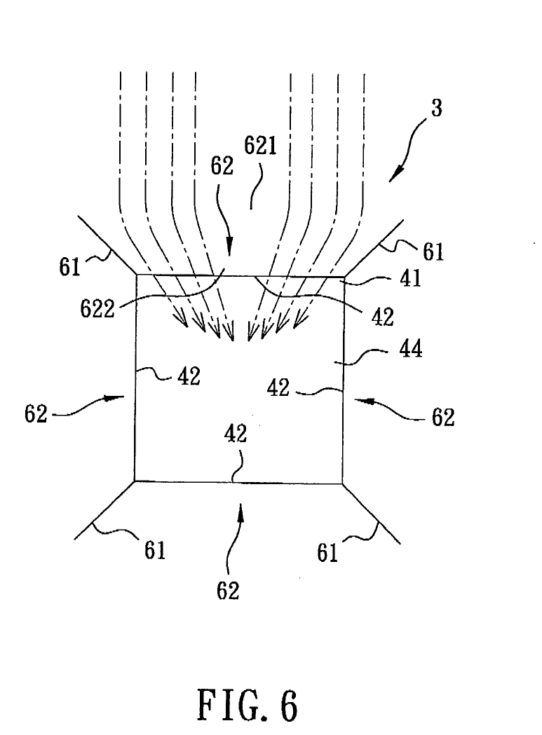

Referring further to FIG. 6, each wind guiding unit 6 is disposed on a respective one of the corners 41 of the structural frame 4 and has a wind guiding member 61, which is a wind guiding plate fixed to the respective one of the corners 41 of the structural frame 4 in this embodiment. The wind guiding members 61 of any adjacent two of the wind guiding units 6 define a wind channel 62 that converges toward a corresponding one of the sides 42 of the structural frame 4 therebetween. Each wind channel 62 has a wind outlet end 622 proximate to the corresponding one of the sides 42 of the structural frame 4, and a wind inlet 621 distal from and wider than the corresponding one of the sides 42 of the structural frame 4. Therefore, wind can be guided by the adjacent two wind guiding members 61 into the accommodating spaces 44 via the corresponding wind channel 62, as indicated by the imaginary arrows in FIG. 6.

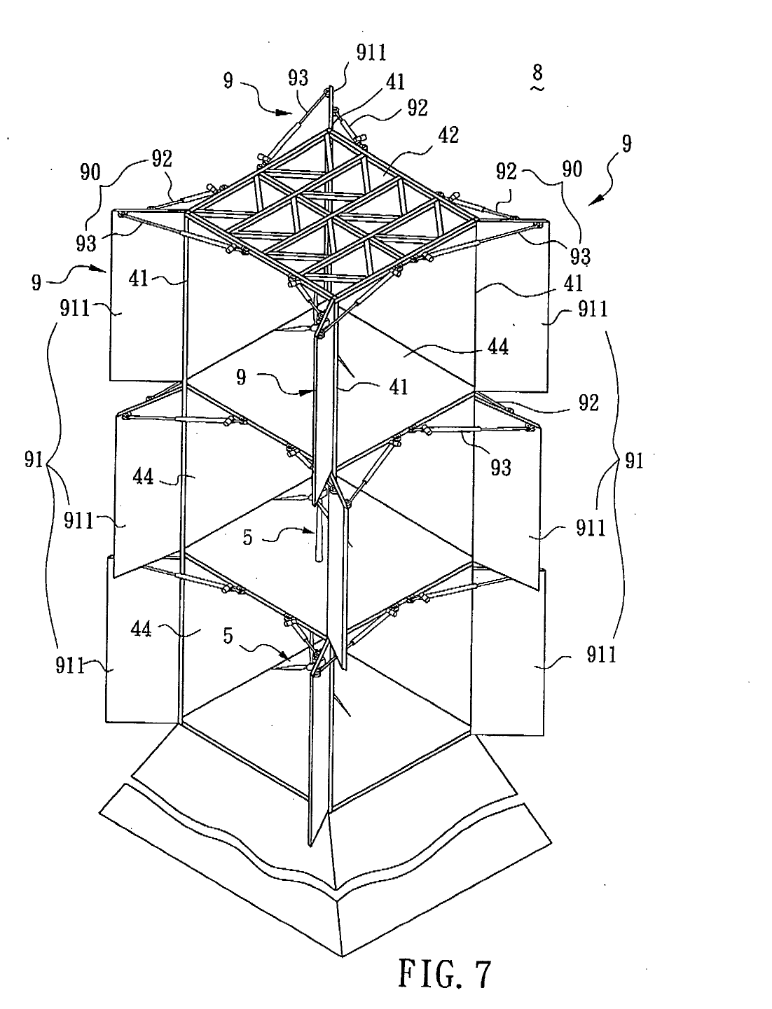

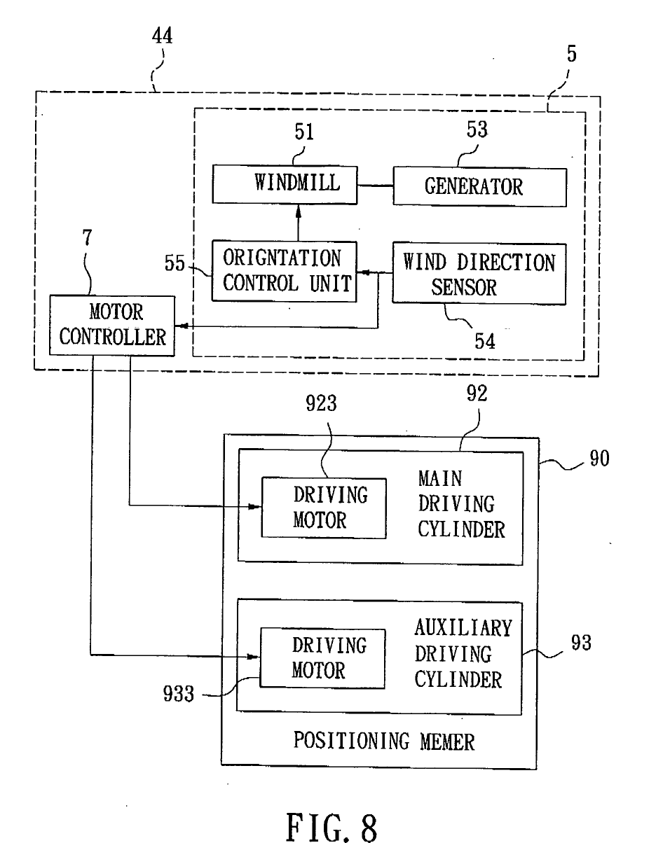

FIGS. 7 and 8 illustrate the second preferred embodiment of an apparatus 8 for generating electric power from wind according to this invention, which is a modification of the first preferred embodiment. Unlike the previous embodiment, the wind guiding member 91 of each of the wind guiding units 9 includes a plurality of wind guiding plates 911 connected pivotally to a corresponding one of the corners 41 of the structural frame 4 and corresponding respectively to the accommodating spaces 44 in the structural frame 4. Each wind guiding unit 9 further includes a plurality of positioning members 90, each of which is connected between a corresponding one of the wind guiding plates 911 and the structural frame 4 and is controlled in response to the wind direction signal received from the wind direction sensor 54 of the corresponding one of the electric generating units 5 so as to position the corresponding one of the wind guiding plates 911 at a desired orientation with respect to the wind direction.

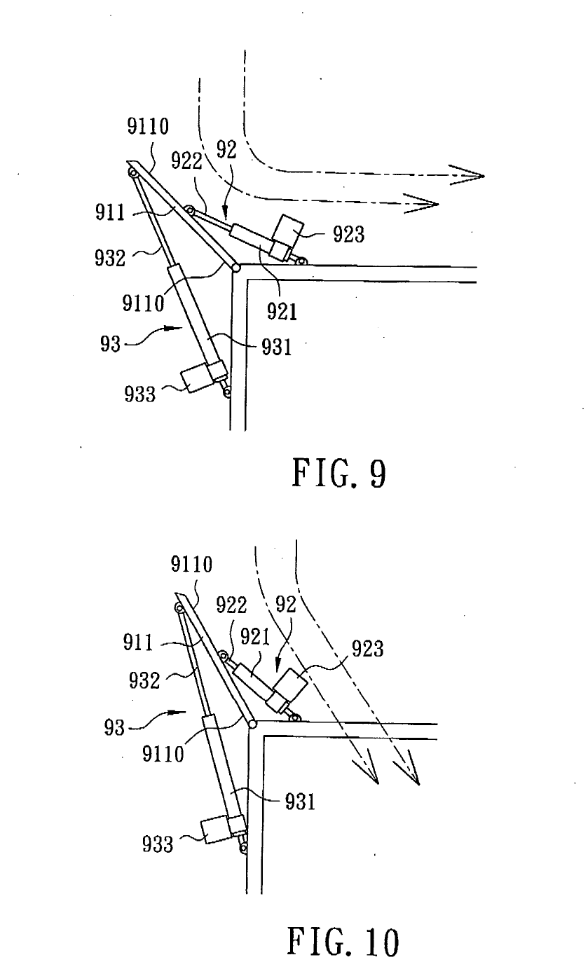

Referring further to FIGS. 9 and 10, in this embodiment, each positioning member 90 includes main and auxiliary driving cylinders 92, 93, each of which has a cylinder body 921, 931 connected pivotally to the structural frame 4, a piston rod 922, 932 coupled movably to the cylinder body 921, 931 and connected pivotally to a respective one of opposite side surfaces 9110 of the corresponding one of the wind guiding plates 911, and a driving motor 923, 933 mounted on the cylinder body 921, 931 and operable so as to drive the piston rod 922, 932.

The apparatus 8 further includes a plurality of motor controllers 7 (only one is shown in FIG. 8) corresponding respectively to the accommodating spaces 44 in the structural frame 4. Each of the motor controllers 7 is coupled electrically to the wind direction sensor 54 of a corresponding one of the electric generating units 5 and the driving motors 923, 933 of the main and auxiliary driving cylinders 92, 93 of a corresponding one of the positioning members 90 of each of the wind guiding units 9 such that each of the motor controllers 7 controls the driving motors 923, 933 of the main and auxiliary driving cylinders 92, 93 of the corresponding one of the positioning members 90 of each of the winding guiding units 9 in response to the wind direction signal received from the wind direction sensor 54 of the corresponding one of the electric generating units 5 to drive the piston rods 922, 932 of the main and auxiliary driving cylinders 92, 93 so as to position the corresponding one of the wind guiding plates 911 at the desired orientation with respect to the wind direction. As such, wind can be guided by the corresponding wind guiding plate 911 positioned by the corresponding positioning member 90, as indicated by the imaginary arrows in FIGS. 9 and 10.

The following are some of the advantages attributed to the apparatus 3, 8 for generating electric power from wind of the present invention:

1. Due to the presence of the wind guiding units 6, 9, wind can be effectively guided into the accommodating spaces 44 via the wind channel 62. Therefore, the amount of wind blowing into the accommodating spaces 44 can be increased, thereby resulting in a corresponding increase in the generated amount of electric power.

2. In order to utilize wind energy from various directions, each guiding plate 911 can be easily positioned at the desired position with respect to the actual wind direction by the corresponding positioning member 90 based on the wind direction signal from the corresponding wind direction sensor 54 without the need for rotating the structural frame 4, thereby reducing power consumption.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. An apparatus for generating electric power from wind that blows in a wind direction, said apparatus comprising:
a structural frame configured with a vertical array of accommodating spaces and having two pairs of sides, each pair of said sides being opposite to each other, said sides defining four corners;
a plurality of electric generating units, each of which includes
a windmill mounted rotatably in a respective one of said accommodating spaces and operable so as to face the wind and so as to convert wind energy into a mechanical rotary power output, and
a generator coupled to said windmill to convert the mechanical rotary power output into electric power; and
four wind guiding units, each of which is disposed on a respective one of said corners of said structural frame and has a wind guiding member, said wind guiding members of any adjacent two of said wind guiding units defining a wind channel that converges toward a corresponding one of said sides of said structural frame therebetween, each of said wind channels having a wind outlet end proximate to the corresponding one of said sides of said structural frame, and a wind inlet end distal from and wider than the corresponding one of said sides of said structural frame.

2. The apparatus as claimed in claim 1, wherein each of said accommodating spaces is rectangular.

3. The apparatus as claimed in claim 1, wherein said wind guiding member of each of said wind guiding units includes a wind guiding plate fixed to the respective one of said corners of said structural frame.

4. The apparatus as claimed in claim 1, wherein each of said electric generating units further includes:
a wind direction sensor for generating a wind direction signal in accordance with the wind direction; and
an orientation control unit coupled electrically to said wind direction sensor and said windmill, said orientation control unit controlling rotation of said windmill about a vertical axis in response to the wind direction signal received from said wind direction sensor so as to enable said windmill to face the wind.

5. The apparatus as claimed in claim 4, wherein said wind guiding member of each of said wind guiding units includes a plurality of wind guiding plates connected pivotally to the respective one of said corners of said structural frame and corresponding respectively to said accommodating spaces in said structural frame, each of said wind guiding units further including a plurality of positioning members, each of which is connected between a corresponding one of said wind guiding plates and said structural frame and is controlled in response to the wind direction signal received from said wind direction sensor of the corresponding one of said electric generating units so as to position the corresponding one of said wind guiding plates at a desired orientation with respect to the wind direction.

6. The apparatus as claimed in claim 5, wherein each of said positioning members includes main and auxiliary driving cylinders, each of which has a cylinder body connected pivotally to said structural frame, a piston rod coupled movably to said cylinder body and connected pivotally to a respective one of opposite side surfaces of the corresponding one of said wind guiding plates, and a driving motor mounted on said cylinder body, said apparatus further comprising a plurality of motor controllers corresponding respectively to said accommodating spaces in said structural frame, each of said motor controllers being coupled electrically to said wind direction sensor of a corresponding one of said electric generating units and said driving motors of said main and auxiliary driving cylinders of a corresponding one of said positioning members of each of said wind guiding units such that each of said motor controllers controls said driving motors of said main and auxiliary driving cylinders of the corresponding one of said positioning members of each of said winding guiding units in response to the wind direction signal received from said wind direction sensor of the corresponding one of said electric generating units to drive said piston rods of said main and auxiliary driving cylinders so as to position the corresponding one of said wind guiding plates at the desired orientation with respect to the wind direction.
